(19) United States
(12) Patent Application Publication
(10) Pub. No.: US 2012/0116875 A1
(43) Pub. Date: May 10, 2012

(54) PROVIDING ADVERTISEMENTS BASED ON USER GROUPING

(75) Inventors: Gang Wang, Beijing (CN); Yajun Wang, Beijing (CN); Pinyan Lu, Beijing (CN); Zheng Chen, Beijing (CN)

(73) Assignee: Microsoft Corporation, Redmond, WA (US)

(21) Appl. No.: 12/940,436

(22) Filed: Nov. 5, 2010

(51) Int. Cl. G06Q 30/00

(52) U.S. Cl. 705/14.53; 705/14.49

(57) ABSTRACT

Techniques for providing advertisements in association with electronic content are provided. The advertisements may be provided with electronic content that satisfies a content request made by a particular individual. The advertisements provided in association with the electronic content may depend on the results of an auction between advertisers submitting bids to have their respective advertisements provided in association with the electronic content. The bids may be submitted with respect to different value groups. Each value group includes individuals that may provide an estimated amount of value to a respective advertiser as a customer.

### BACKGROUND

Advertisements are often provided to individuals in association with electronic content. For example, advertisements may be displayed in association with website content and emails. In addition, search engines may display advertisements in association with search results provided in response to a search request including one or more keywords.

In some cases, an auction is conducted to determine the advertisements that are provided in association with electronic content. In particular, advertisers may submit bids with respect to particular electronic content, such as with respect to particular keywords in a search request. The auction then determines the advertisers whose advertisements will be displayed in conjunction with the particular electronic content according to the highest bidders. In some instances, the advertisements of advertisers submitting the highest bids are displayed more prominently than the advertisements of advertisers submitting lower bids, such as at the top of a webpage or first in a list of advertisements. Advertisers often submit bids in amounts that will maximize their return on investment. That is, advertisers may submit bids that will minimize advertising expenses, while maximizing revenue.

A variety of methods are utilized to determine payment that an advertiser provides to an electronic content publisher when the advertiser's advertisements are displayed in association with electronic content provided by the publisher. In some scenarios, an advertiser is charged each time that its advertisements are displayed in association with electronic content. This payment model may be referred to as “pay-per-impression.” In other cases, an advertiser may be charged each time that an individual selects one of the advertiser's advertisements. This payment model may be referred to as “pay-per-click.” In still other situations, an advertiser is charged when an individual that has selected an advertiser's advertisement takes an action with respect to a website of the advertiser, such as purchasing a product. This payment model may be referred to as “pay-per-action.”

For each payment model, either the advertisers or the electronic content publishers assume a disparate amount of risk with respect to the risk assumed by the other party. In some cases, this may limit the number of advertisers participating in auctions to display advertisements in association with electronic content. Additionally, the bids submitted by advertisers may not be optimal in order to achieve a maximum return on investment because advertisers are not able to predict whether or not a particular individual may provide value as a customer. Further, advertisers are not able to submit bids in such a way that their advertisements are provided to a targeted group of potential customers. Thus, the participation of advertisers in auctions to display advertisements in association with electronic content may be limited for these reasons, as well.

### SUMMARY

This disclosure describes providing advertisements to individuals according to value groups of the individuals. In particular, advertisers may participate in an auction to have their advertisements provided in association with particular electronic content by submitting bids with respect to certain groups of individuals. In some cases, the individuals may be grouped into one or more value groups. Each value group comprises individuals that are predicted to provide a threshold amount of value to the respective advertisers as a customer. That is, each value group includes individuals that may provide an estimated amount of value to the respective advertisers as a customer. In this way, an advertiser can submit separate bids for one or more of the value groups and optimize their bidding by targeting individuals of certain value groups. Thus, the advertiser may be able to maximize its return on investment by submitting bids that are proportionate to the estimated value provided by individuals of certain value groups to the advertiser as customers and/or based on the importance of the individuals of the respective value groups to the advertiser as customers.

### BRIEF DESCRIPTION OF THE CONTENTS

The detailed description is described with reference to the accompanying Figures. In the Figures, the left-most digit(s) of a reference number identifies the Figure in which the reference number first appears. The use of the same reference numbers in different Figures indicates similar or identical items or features.

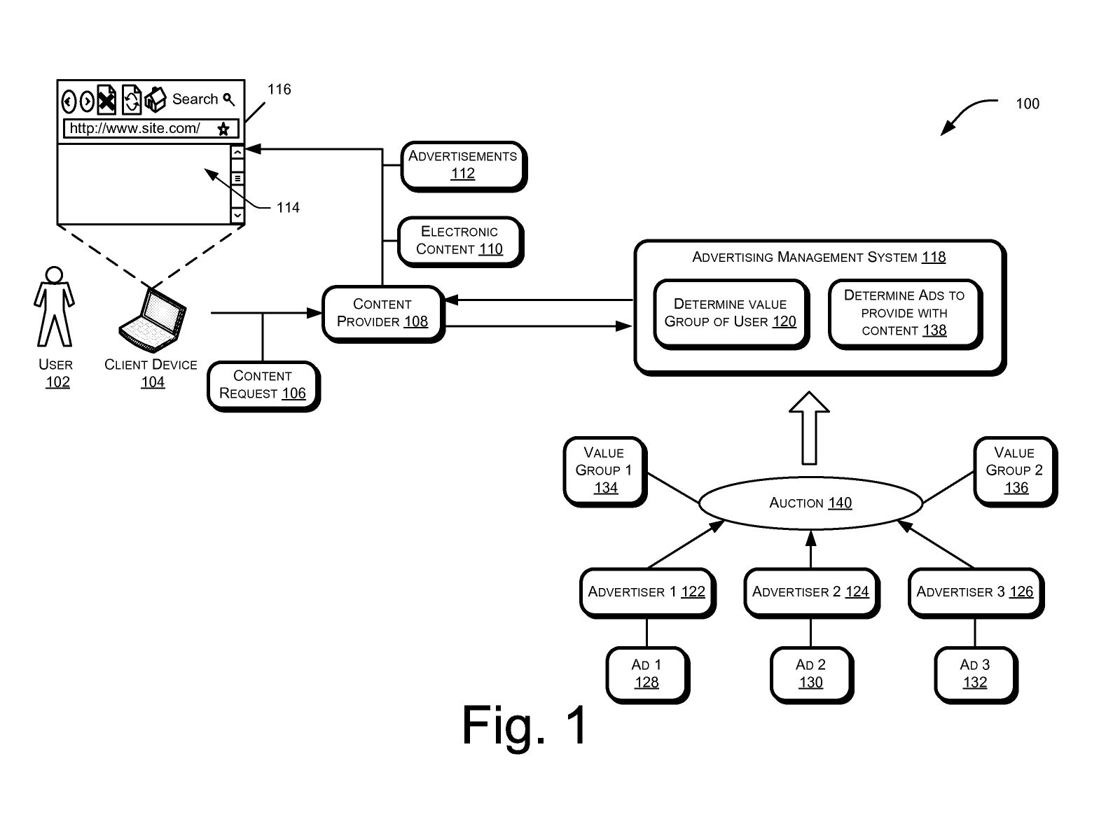

FIG. 1 illustrates an architecture to provide advertisements to a user of a client device in response to a request for content based on a value group of the user with respect to the advertisers and the results of an auction between the advertisers.

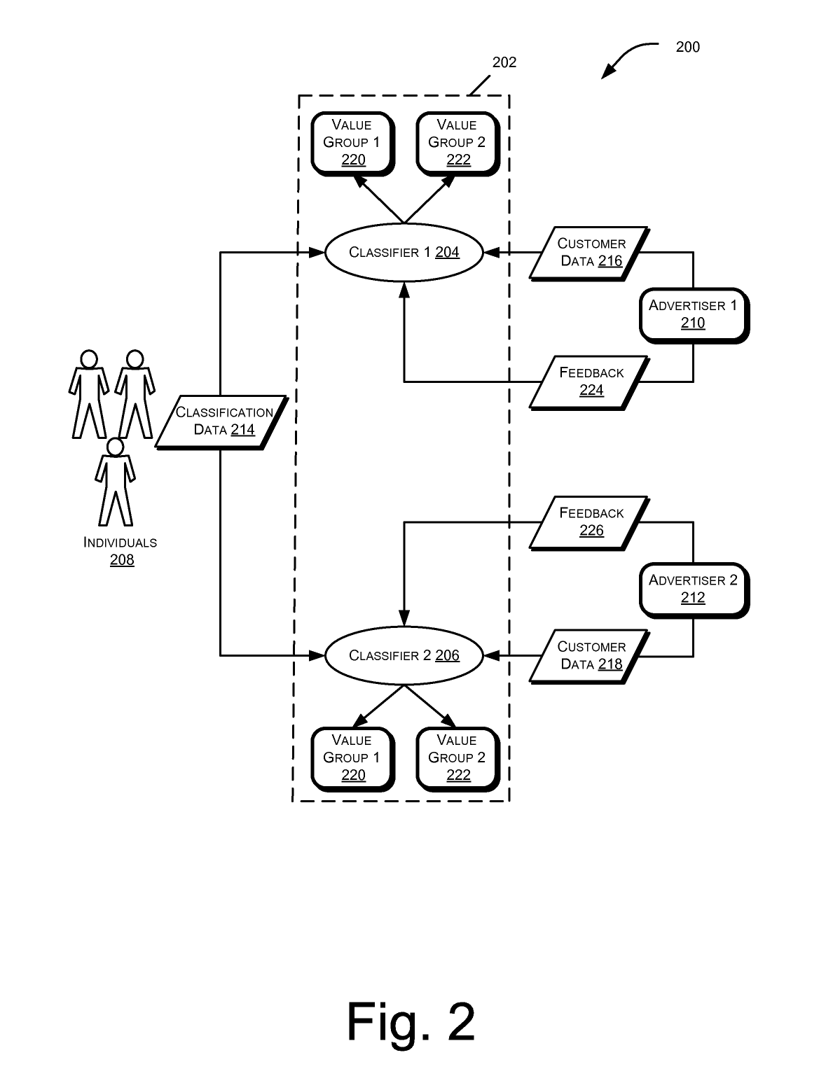

FIG. 2 illustrates an architecture to train classifiers of respective advertisers based on customer data of the advertisers, classification data of a number of individuals, and feedback relating to the classifiers provided by the advertisers.

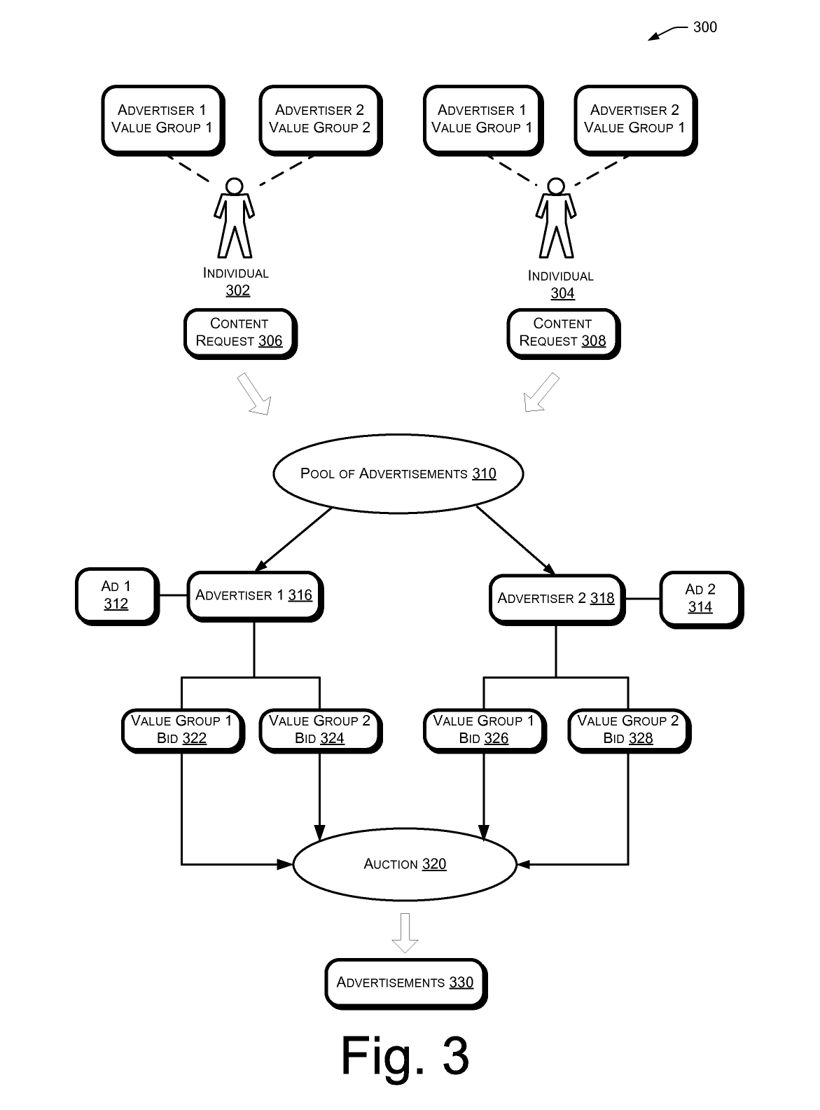

FIG. 3 illustrates a framework utilized to conduct an auction between advertisers in order to provide advertisements to individuals associated with a respective value group.

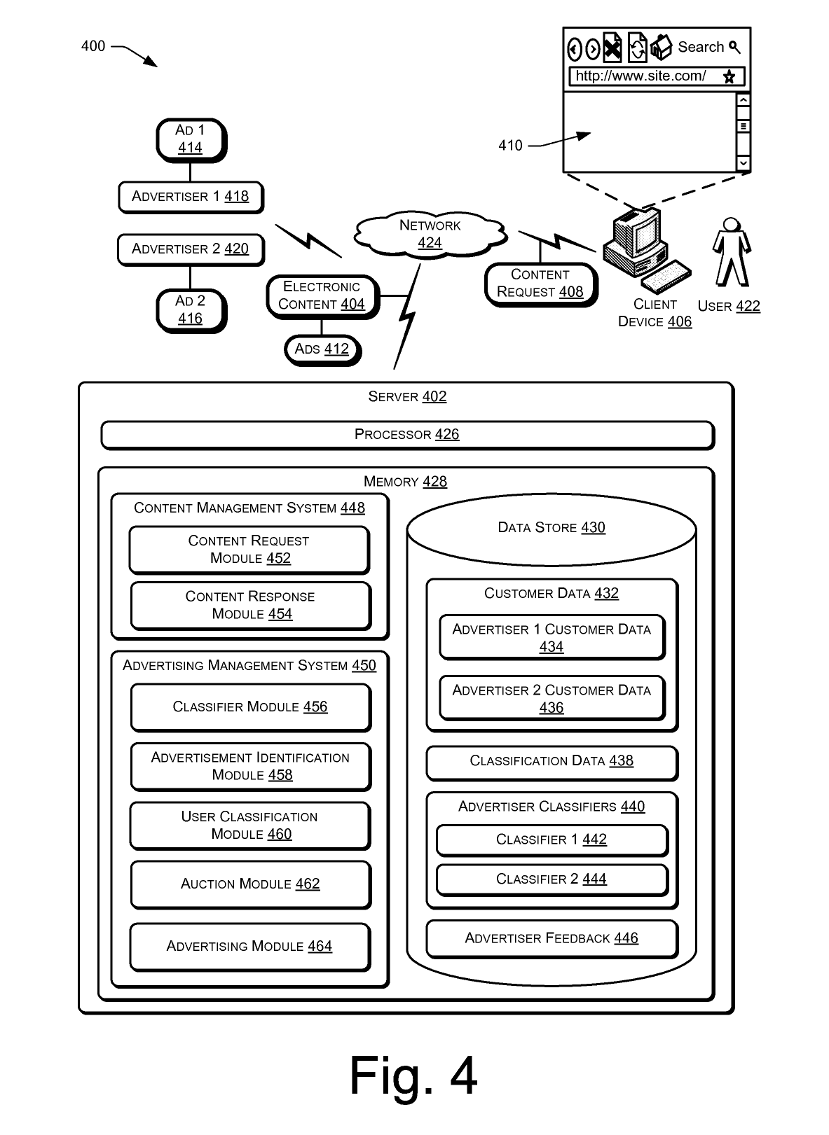

FIG. 4 illustrates a system to provide advertisements to a user of a client device in response to a request for content based on an auction between advertisers and a value group of the user.

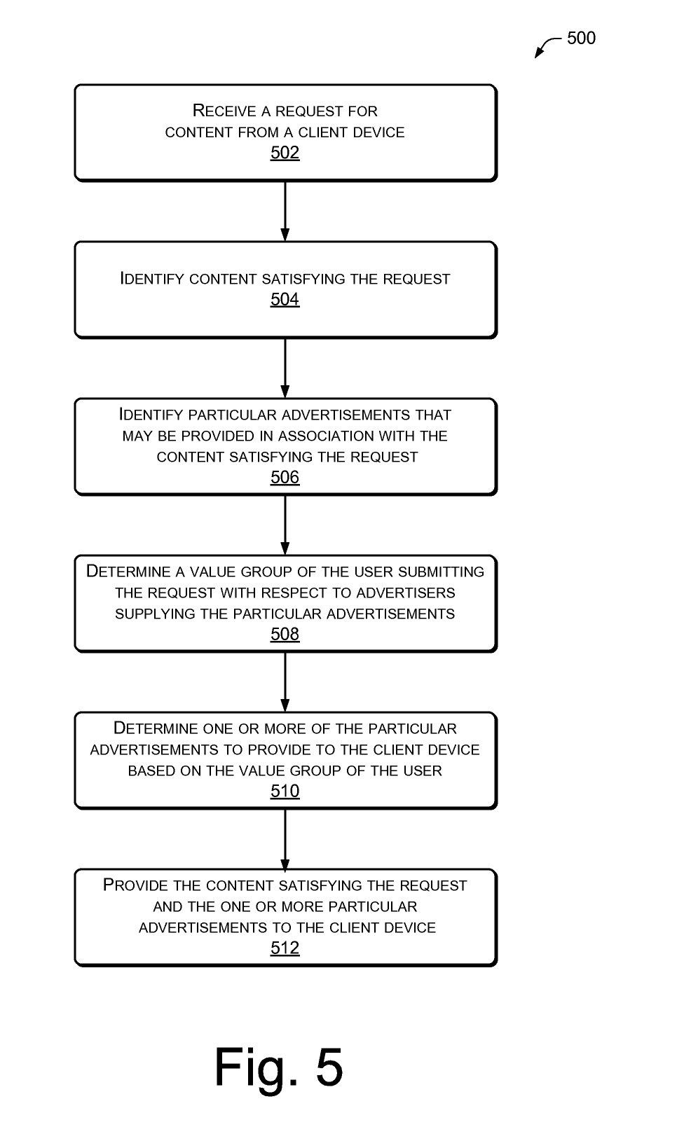

FIG. 5 illustrates a process to provide advertisements to a user of a client device in response to a request for content based on an auction between advertisers and a value group of the user.

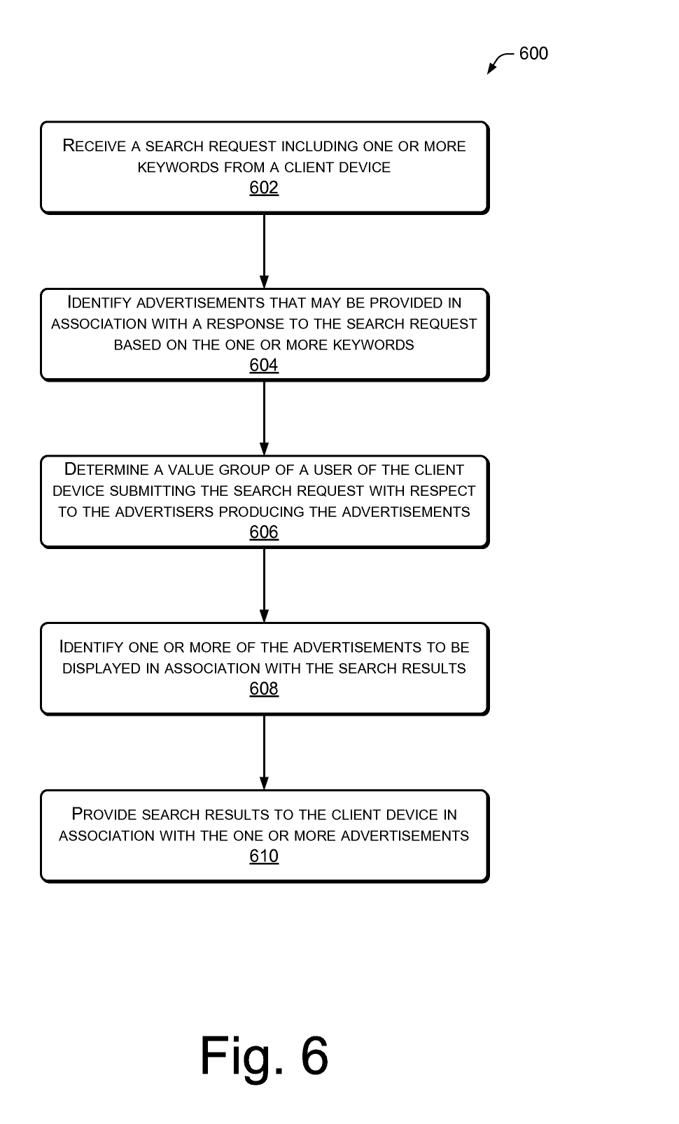

FIG. 6 illustrates a process for a search engine to provide advertisements to a user of a client device in response to a search request based on a value group of the user.

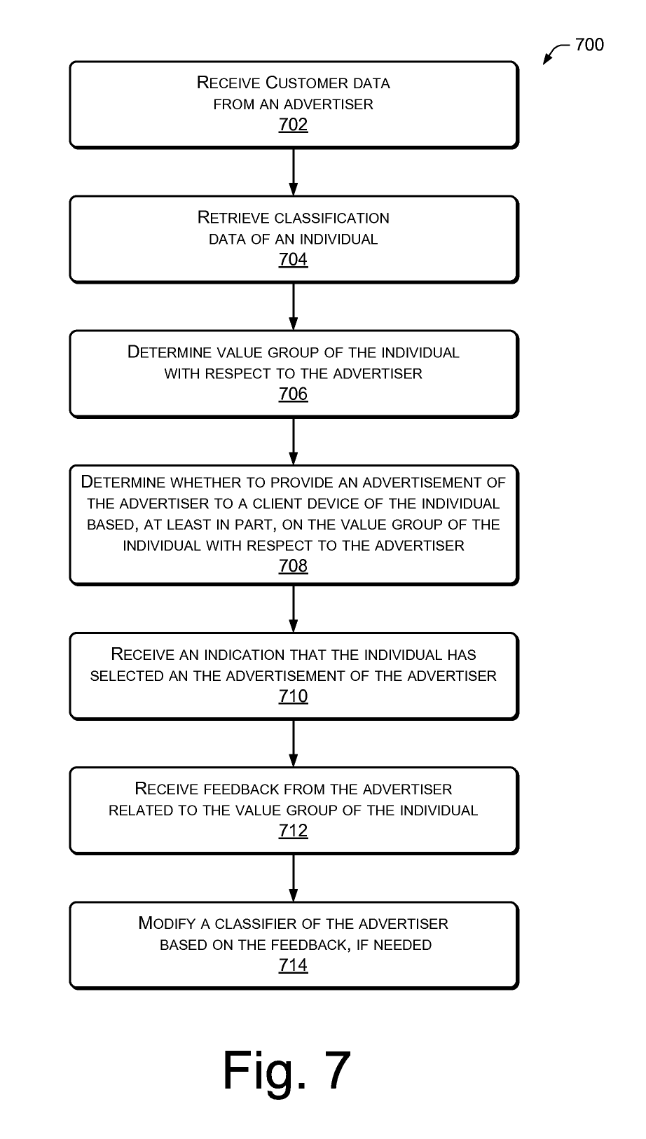

FIG. 7 illustrates a process to train and modify a classifier of an advertiser based on customer data of the advertiser, classification data of individuals, and feedback provided by the advertiser.

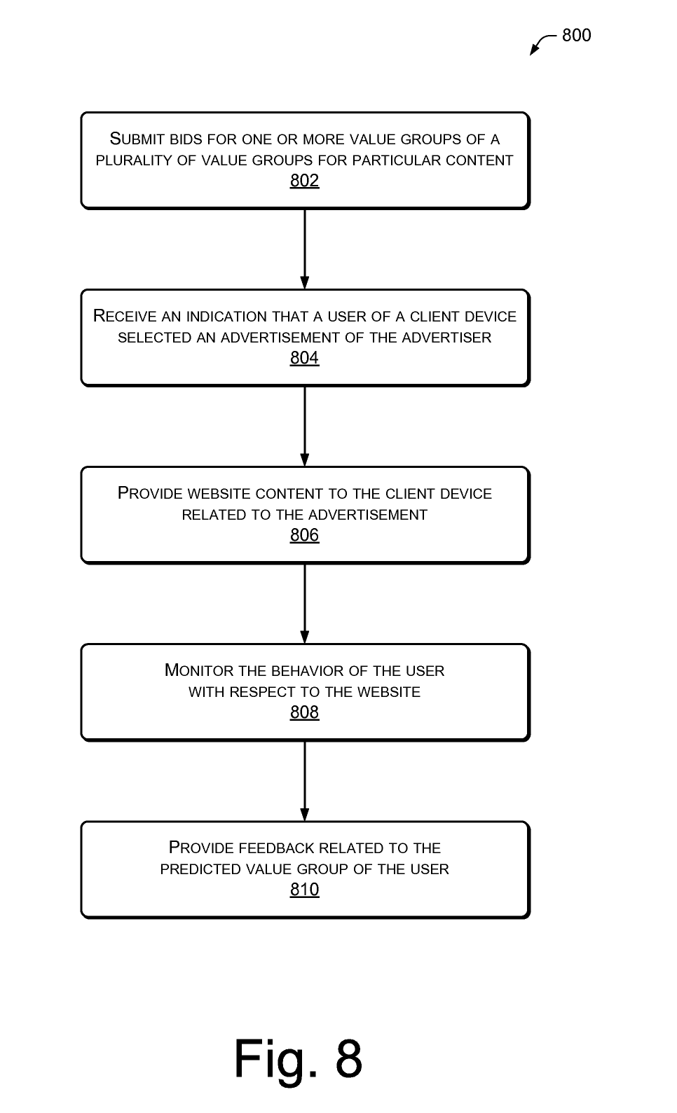

FIG. 8 illustrates a process for an advertiser to submit bids for an auction based on a value group of respective individuals and to provide advertisements based on the bids.

### DETAILED DESCRIPTION

FIG. 1 illustrates an architecture 100 to provide advertisements to a user of a client device in response to a request for content based on a value group of the user with respect to the advertisers and the results of an auction between the advertisers. In particular, a user 102 of a client device 104 may submit a content request 106 to a content provider 108. In some cases, the content request 106 may include a query to a search engine that includes one or more keywords. The content request 106 may also include a request for electronic content, such as a webpage. The client device 104 may include a laptop computer, a desktop computer, a smart phone, a mobile handset, a personal digital assistant (PDA), a portable navigation device, a portable gaming device, a tablet computer, a watch, a portable media player, another computing device, and so on.

In response to receiving the content request 106, the content provider 108 may identify electronic content 110 satisfying the content request 106. For example, the content provider 108 may determine search results satisfying a search query. Additionally, the content provider 108 may identify content of a requested webpage.

The electronic content 110 may be provided to the client device 104 in association with advertisements 112. In the implementation shown in FIG. 1, the electronic content 110 and the advertisements 112 may be provided to the client device 104 as a webpage 114 within a user interface 116. The user interface 116 may be provided via a browser or other application executing on the client device 104.

In some cases, the advertisements 112 are based on the electronic content 110. For example, the advertisements 112 may be related to the content of an email provided in response to the content request 106. In another example, the advertisements 112 may be related to content of a webpage showing a news article from a website. The advertisements 112 may also be based on content of the content request 106, such as keywords of a search query.

When the one or more advertisements 112 are to be provided to the client device 104 in association with the electronic content 110, the content provider 108 may communicate with an advertising management system 118. The advertising management system 118 may determine the advertisements 112 to provide in association with the electronic content 110. In some cases, the advertising management system 118 may be a system separate from the content provider 108, yet operated by the same entity.

In an illustrative implementation, at 120, the advertising management system 118 may determine a value group of the user 102 with respect to one or more advertisers, such as the advertisers 122-126. The advertisers 122-126 are associated with respective advertisements 128-132. In some cases, the advertisements 128-132 may include subject matter related to the electronic content 110. The value group of the user 102 may indicate an estimated amount of value to be provided by the user 102 to the advertisers 122-126 as a customer. For example, the advertising management system 118 may determine that the user 102 is likely to purchase items from the first advertiser 122 or is likely to spend a threshold amount of time browsing a website of the advertiser 122 (i.e. exceed a threshold dwell time) and classify the user 102 according to a first value group 134 with respect to the first advertiser 122. In another example, the advertising management system 118 may determine that the user 102 is not likely to purchase items from the second advertiser 124 or that the user 102 will spend less than a threshold amount of time browsing the website of the advertiser 124 and classify the user 102 according to a second value group 136 with respect to the second advertiser 124. In some instances, the advertisers 122-126 may be merchants that offer one or more items for sale, such as one or more goods and/or services. In other situations, the advertisers 122-126 may represent entities that manage advertising services for a respective merchant.

At 138, the advertising management system 118 may determine the advertisements 112 to be provided in association with the electronic content 110. The advertisements 112 may be selected based on an auction 140 between the advertisers 122-126. The auction 140 may be conducted before or after the content request 106 has been submitted to the content provider 108.

In a particular implementation, the advertisers 122-126 may submit bids for one or more value groups, such as the value groups 134 and 136. For example, the first advertiser 122 may submit a bid of a first amount with respect to the first value group 134 and a bid of a second amount with respect to the second value group 136. In some cases, the advertisers 122-126 may choose not to submit bids with respect to at least one of the value groups 134, 136.

The results of the auction 140 indicate the advertisers 122-126 submitting the highest bids associated with the value group of the user 102 with respect to each of the advertisers 122-126. To illustrate, the user 102 may be associated with the first value group 134 with respect to the first advertiser 122 and the second advertiser 124, and with the second value group 136 with respect to the third advertiser 126. In this illustration, the bids submitted by the first advertiser 122 and the second advertiser 124 with respect to the first value group 134 and the bid submitted by the third advertiser 126 with respect to the second value group 136 are compared to each other.

The respective ads 128-132 of the advertisers 122-126 are treated according to the results of the auction 140. In some cases, the advertisement associated with the advertiser submitting the highest bid is provided with the electronic content 110. For example, if the first advertiser 122 submitted the highest bid with respect to the user 102, then the one or more advertisements 112 provided to the client device 104 would include the first advertisement 128. In other cases, multiple advertisements from the advertisers 122-126 may be sent in association with the electronic content 110 and the results of the auction 140 may determine the treatment of the advertisements 128-132 with respect to each other. Specifically, when the highest bid with respect to the user 102 is submitted by the first advertiser 122 and the next highest bid is submitted by the second advertiser 124, the first advertisement 128 may be displayed more prominently than the second advertisement 130. In some instances, the first advertisement 128 may be displayed first in a list of advertisements with the second advertisement 130 appearing below the first advertisement 128 in the list. In other situations, the first advertisement 128 may be displayed at the top of the page or in the middle of the page, while the second advertisement 130 is displayed at the bottom of the page or to one side of the page. In still other cases, the first advertisement 128 may occupy a larger area of the page than the second advertisement 130.

By classifying users according to different value groups with respect to a number of different advertisers and allowing the advertisers to submit bids for each value group, the advertisers are able to directly target a particular group of potential customers. Thus, the bids submitted by the advertisers may be closer to an optimal value to maximize the return on investment for the advertisers because bids are not submitted with respect to the entire population of individuals, but with respect to a particular value group or groups. Accordingly, advertiser participation in auctions for advertisements may increase.

FIG. 2 illustrates an architecture 200 to train classifiers of respective advertisers based on customer data of the advertisers, classification data of a number of individuals, and feedback relating to the classifiers provided by the advertisers. In particular, the architecture 200 includes an advertising management system 202 that trains classifiers 204 and 206 and that utilizes the classifiers 204 and 206 to place a number of individuals 208 into one or more groups. The individuals 208 may be placed into groups in order to determine advertisements to provide to each respective individual 208 in association with particular content requested by a respective individual 208. Each of the classifiers 204 and 206 may be associated with a corresponding advertiser, such as advertisers 210 and 212.

The classifiers 204 and 206 may be trained with data associated with the individuals 208 and data associated with the advertisers 210 and 212. In particular, the classifiers 204 and 206 may be trained based on classification data 214 of the individuals 208. The classification data 214 may include data indicating search queries submitted by the individuals 208, browsing history of the individuals 208, advertisements previously selected by the individuals 208, preferences of the individuals 208, profile information of the individuals 208, other information relating to the individuals 208, or a combination thereof. Additionally, the classifiers 204 and 206 may also be trained on customer data 216 and 218 provided by the advertisers 210 and 212. The customer data 216 and 218 may include data indicating purchases by customers from the advertisers 210, 212, dwell time of customers on websites of the advertisers 210, 212, number of pages of the websites of the advertisers visited by customers, other information relating to customers of the advertisers 210, 212, or a combination thereof. Further, the classifiers 204, 206 may be trained on additional data, such as data relating to a type of search query utilized to access a website of the advertisers 210, 212 (e.g. a keyword query or a navigational query) and/or data indicating features of webpages of the advertisers 210, 212 (e.g. animation, images, video, and the like).

The classifiers 204 and 206 may be utilized to place each of the individuals 208 into a particular group. In some cases, the classifiers 204 and 206 may place the individuals into groups based on an estimate of value to be provided to a particular advertiser 210, 212 by the particular individual 208. For example, the classifiers 204, 206 may classify each of the individuals as being associated with a first value group 220 or a second value group 222 with respect to each advertiser 210, 212. In some cases, an individual 208 may be classified according to a different value group 220, 222 for each advertiser. For example, one individual 208 may be classified in association with the first value group 220 with respect to the first advertiser 210 and classified in association with the second value group 222 with respect to the second advertiser 212.

By utilizing the classification data 214 and the customer data 216, 218, the classifiers 204, 206 may identify individuals 208 that are likely to purchase products and/or services offered by the advertisers 210, 212. In addition, the advertisers 210, 212 may be interested in submitting bids to have their advertisements provided to the individuals 208 based on the potential purchase of products and/or services of the advertisers 210, 212 by the individuals 208. In an illustrative implementation, the classification data 214 for a particular individual 208 may indicate that the particular individual 208 often visits websites related to consumer electronics. Additionally, the particular individual 208 may submit search queries with keywords related to smart phones and profile information of the particular individual 208 may indicate that the particular individual 208 lives in Seattle, Wash. Further, the customer data 216 may indicate that the advertiser 210 is a seller of smart phones and that a large number of purchases of their smart phones are made by residents of the state of Washington. In this case, the first classifier 204 may determine that the likelihood of the particular individual 208 being interested in a smart phone offered by the first advertiser 210 is relatively high and place the particular individual into a value group 220, 222 that corresponds to the individuals 208 that may provide a particular amount of value to the first advertiser 210. In this way, the first advertiser 210 may direct funds to bidding for the individuals 208 of particular value classes 220, 220 based on a business plan to target the individuals 208 associated with the particular value groups 220, 222.

In some situations, the advertisers 210, 212 may submit feedback 224, 226 to the advertising management system 202. The feedback 224, 226 may be utilized to further train the classifiers 204, 206 and improve the accuracy of each respective classifier 204, 206. Continuing with the example from above, the first advertiser 210 may submit the feedback 224 indicating that the particular individual 208 purchased a smart phone after selecting an advertisement provided by the first advertiser 210 and visiting a website provided by the advertiser 210. In another situation, the first advertiser 210 may submit the feedback 224 indicating that the particular individual 208 visited the website of the first advertiser 210 and browsed several pages of the website, but did not purchase a smart phone. In still another instance, the advertiser 210 may provide the feedback 224 indicating that the particular individual 208 selected an advertisement of the first advertiser 210, but soon after visiting the website of the advertiser 210 moved to a different website. In each of these situations, the feedback 224 may be utilized to further train the first classifier 204.

The classifiers 204, 206 may be trained according to any number of machine learning techniques. For example, a hidden Markov model or a Naïve Bayes model may be utilized to train the classifiers 204, 206. A first portion of the classification data 214, the customer data 216, 218, and/or the feedback 224, 226 may be utilized as training data for the classifiers 204 and 206, while a second portion of the classification data 214, the customer data 216, 218, and/or the feedback 224, 226 is utilized in testing the classifiers 204, 206. The portions of the classification data 214, the customer data 216, 218, and/or the feedback 224, 226 utilized in training and testing the classifiers 204, 206 may be optimized in order to provide accurate grouping of the individuals 208.

In a particular implementation, a classifier, such as the classifiers 204, 206 may be trained to determine whether a particular individual 208 clicking on an advertisement of a respective advertiser 210, 212 will spend a threshold amount of time on the website of the advertiser 210, 212 and/or purchase an item offered by the advertiser 210, 212. Let φᵢ be a mapping from a set of clicks on advertisements {<u,q,p>ₜ} to certain features and having the form:

φᵢ( [symbol] u,q,p [symbol] ₜ)= [symbol] φ_{i,t}(u),φ_{i,t}(q),φ_{i,t}(p)

[symbol]

where φ_{i,t}(u), φ_{i,t}(q), φ_{i,t}(p) are user-based features, query-based features, and page-based features at time t respectively, with a respective click on an advertisement taking place at t. User-based features may correspond to characteristics of a particular individual 208, such as a profession or interests of a particular individual 208. For example, a user-based feature may indicate that a particular individual 208 is a photographer or photography enthusiast, and is, thus, more likely to purchase items related to photography. A query-based feature may indicate that a query is a keyword query or a navigational query directed to a particular website. Navigational queries to a website of a particular advertiser 210 or 212 may indicate a higher potential that a particular individual 208 is interested in items offered by the particular advertiser 210 or 212. Page-based features may relate to characteristics of webpages provided by the respective advertisers 210, 212. For example, some webpages may include features, such as graphics, animations, and the like, that may dispose some of the individuals 208 toward purchasing items offered by the advertisers 210, 212.

For a given click having features [symbol] u,q,p [symbol] ₜ the value of u for a given advertiser aᵢ, such as the advertisers 210, 210, is:

$${φ}_{i , t} ( u ) = \frac{\vert {X}_{i , u , < t}^{+} \vert + α \vert {X}_{i < t}^{+} \vert}{\vert {X}_{i , u , < t} \vert + α \vert {X}_{i < t} \vert}$$

$$where$$

$${X}_{i , u , < t}^{+} = \{ {〈 u , \cdot , \cdot 〉}_{{t}^{′}} \vert 〈 u , \cdot , \cdot 〉 ∈ {X}_{i}^{+} Λ {t}^{′} < t \}$$

and X_{i,u,<t}⁺ consists of clicks on a website of advertiser aᵢ by u and before t that result in a dwell time above a particular threshold or in a purchase of an item offered by the advertiser aᵢ. Additionally,

X_{i,<t}⁺={ [symbol] •,•,• [symbol] _{t′}| [symbol] •,•,• [symbol] εXᵢ⁺ [symbol] t′<t}

where X_{i,<t}⁺ consists of all clicks on the website of advertiser aᵢ before t that result in a dwell time above a particular threshold or in a purchase of an item offered by the advertiser aᵢ. Similarly, for all clicks:

X_{i,u,<t}={ [symbol] u,•,• [symbol] _{t′}| [symbol] u,•,• [symbol] εXᵢ [symbol] t′<t}

X_{i,<t}={ [symbol] •,•,• [symbol] _{t′}| [symbol] •,•,• [symbol] εXᵢ [symbol] t′<t}

Further, for φᵢ(q)

$${φ}_{i , t} ( q ) = \frac{\vert {X}_{i , q , < t}^{+} \vert + α \vert {X}_{i < t}^{+} \vert}{\vert {X}_{i , q , < t} \vert + α \vert {X}_{i < t} \vert}$$

and for φᵢ(p)

$${φ}_{i , t} ( p ) = \frac{\vert {X}_{i , p , < t}^{+} \vert + α \vert {X}_{i < t}^{+} \vert}{\vert {X}_{i , p , < t} \vert + α \vert {X}_{i < t} \vert}$$

When adopting a Naïve Bayes model for a classifier:

$$\begin{matrix}Pr ( 1 \vert {〈 u , q , p 〉}_{t} ) = Pr ( {〈 u , q , p 〉}_{t} \vert 1 ) \cdot Pr ( 1 ) \\ = \frac{{\prod }_{e ∈ \{ u , q , p \}} Pr ( 1 \vert e ) \cdot }{Pr ( 1 )} \cdot \\ {\prod }_{e ∈ \{ u , q , p \}} Pr ( e ) ∝ Pr ( u \vert 1 ) Pr ( q \vert 1 ) Pr ( p \vert 1 ) \\ = {φ}_{i , t} ( u ) {φ}_{i , t} ( q ) {φ}_{i , t} ( p )\end{matrix}$$

This classifier predicts a click of a particular individual 208 to result in a dwell time above a threshold or in a purchase of an item offered by the advertiser aᵢ when Pr(1| [symbol] u,q,p [symbol] ₜ) is above a threshold θ.

FIG. 3 illustrates a framework 300 utilized to conduct an auction between advertisers in order to provide advertisements to individuals associated with a respective value group. In particular, the individuals 302 and 304 may be grouped into one or more value groups with respect to each of a number of advertisers by classifiers associated each of the advertisers, such as the classifiers 204, 206 of FIG. 2.

In a particular implementation, the individual 302 may submit a first content request 306 and the individual 304 may submit a second content request 308. The content requests 306, 308 may be search queries including one or more keywords. The content requests 306, 308 may also be requests for content, such as content of a website or content of a message, such as an email.

In some cases, advertisements are to be provided in association with the content satisfying the respective content requests 306, 308. The advertisements may be identified from a pool of advertisements 310. For example, advertisement 312 and/or advertisement 314 produced by respective advertisers 316, 318 may be identified in association with responses to the content requests 306, 308.

The advertisements 312, 314 may be selected from the pool of advertisements 310 for a number of reasons. In some scenarios, the advertisements 312, 314 may be selected because the advertisers 316, 318 submitted bids to have the advertisements 312, 314 provided in association with responses to certain content requests, such as the content requests 306, 308, based on the subject matter of the content requests 306, 308. For example, the advertisers 316, 318 may have submitted bids to have the advertisements 312, 314 displayed in association with content related to search results satisfying keywords of the content request 306, 308. In other situations, the advertisers 316, 318 may have submitted bids to have the advertisements 312, 314 displayed in association with subject matter satisfying the content requests 306, 308. To illustrate, the content request 306 may be a request to view website content, such as a request to view a consumer electronics website, and the advertisers 316, 318 may have submitted bids to have the advertisements 312, 314 provided in association with the website content.

The advertisements provided in association with the respective responses to the content requests 306, 308 may be determined by an auction, such as the auction 320, between a number of advertisers. The auction 320 may be conducted before or after the individuals 302, 304 submit the content requests 306, 308. In a particular example, the advertisers 316, 318 may submit bids 322-328 in order to provide the respective advertisements 312, 314 in association with the responses to the content requests 306, 308. The bids 322-328 may be submitted with respect to particular value groups that may include the individuals 302, 304. For example, the first advertiser 316 may submit the bid 322 with respect to a first value group and submit the bid 324 with respect to a second value group. Additionally, the second advertiser 318 may submit the bid 326 with respect to the first value group and the bid 328 with respect to the second value group.

The amounts of the bids submitted for each value group may differ. To illustrate, the bid 322 may be for a different amount than the bid 324. Thus, the advertisers 316, 318 can allocate certain funds for advertising related to different groups of individuals. Further, while FIG. 3 shows that the advertisers 316, 318 each submit bids for both the first value group and the second value group, in some situations, the advertisers 316, 318 may not submit a bid for one or more of the value groups.

The outcome of the auction 320 determines advertisements 330 to be provided in association with a response to the content request 306 or 308. In particular, the advertisements of advertisers submitting the highest bids are provided in association with the responses to the content requests 306, 308. In addition, the outcome of the auction 320 may determine the treatment of the advertisements 330 when provided with the response to the content request 306 or 308. For example, advertisements of advertisers submitting the highest bids may be displayed more prominently than advertisements of advertisers submitting lower bids. To illustrate, the advertisements of advertisers submitting the highest bids may be displayed first in a list of advertisements, cover a larger area than the other advertisements, be displayed at the top of a webpage, be displayed in line with content of a webpage, or a combination thereof.

In an illustrative implementation, the individual 302 may submit the content request 306 to a content provider. In particular, the content request 306 may be a request for a webpage related to smart phones, such as a news article about a particular smart phone application. In response to the content request 306, the advertisements 312 and 314 are selected from the pool of advertisements 310. The advertisements 312 and 314 may be selected from the pool of advertisements 310 because the advertisements 312, 314 include content related to smart phones. For example, the advertisements 312, 314 may relate to purchasing particular smart phones, smart phone accessories, smart phone applications, and/or smart phone services. In other cases, the advertisements 312, 314 may be selected because the advertisers 316, 318 have indicated interest in the advertisements 312, 314 being displayed in association with webpages having content related to smart phones. In these situations, the advertisements 312, 314 may include content that is not necessarily related to smart phones.

After identifying the advertisements 312, 314 from the pool of advertisements 310, the one or more advertisements to be provided in association with a response to the content request 306 are determined based on the results of the auction 320. The outcome of the auction 320 may be based on one or more value groups associated with the individual 302. In the illustrative example shown in FIG. 3, the individual 302 is associated with a first value group with respect to the first advertiser 316 and with a second value group with respect to the second advertiser 318. The value group(s) of the individual 302 with respect to the advertisers 316, 318 may be determined by classifiers, such as the classifiers 204, 206 of FIG. 2.

Once the value group(s) of the individual 302 are determined, the auction 320 is conducted with the bids of the advertisers 316, 318 that correspond to the value group of the individual 302 with respect to the advertisers 316, 318. In particular, since the individual 302 is associated with the first value group with respect to the first advertiser 316 and the second value group with respect to the second advertiser 318, the auction 320 is conducted with the bid 322 of the first advertiser 316 with respect to the first value group and the bid 328 of the second advertiser 318 with respect to the second value group.

Based on the results of the auction 320, the first advertisement 312 or the second advertisement 314 may be provided in association with a response to the content request 306. For example, when the first advertiser 316 is the winner of the auction 320, the first advertisement 312 may be provided with the response to the content request 306 and when the second advertiser 318 is the winner of the auction 320, the second advertisement 314 may be provided with the response to the content request 306. Further, both of the advertisements 312 and 314 may be provided in association with the response to the content request 306, but the prominence of the advertisements 312, 314 may be determined based on the results of the auction 320. Specifically, the advertisement 312, 314 produced by the winner of the auction 320 may be displayed more prominently on the webpage(s) provided in response to the content request 306.

In another illustrative implementation, the auction 320 may be conducted in conjunction with providing a response to the content request 308 provided by the individual 304. The content request 308 may be for the same webpage as the content request 306. In this implementation, the outcome of the auction 320 is based on the value group(s) of the individual 304 with respect to the advertisers 316, 318. For example, in the implementation shown in FIG. 3, the individual 304 is associated with the first value group with respect to the first advertiser 316 and the first value group with respect to the second advertiser 318. In this case, the bid 322 of the first advertiser 316 with respect to the first value group and the bid 326 of the second advertiser 318 with respect to the second value group are compared to determine the winner of the auction 320. The advertisements 330, such as the first advertisement 312 and/or the second advertisement 314, are provided in association with the response to the content request 308 based on the outcome of the auction 320.

FIG. 4 illustrates a system 400 to provide advertisements to a user of a client device in response to a request for content based on an auction between advertisers and a value group of the user. The system 400 includes a server 402. The server 402 may provide electronic content 404 to the client device 406 in response to a content request 408 sent from the client device 406 to the server 402. In particular, the server 402 may provide a webpage 410 to the client device 406 in response to the content request 408. The webpage 410 may include results from a search query, email content, website content, or a combination thereof.

One or more advertisements 412 may be provided to the client device 406 in association with the electronic content 404. Thus, in addition to the electronic content 404, the webpage 410 may include the one or more advertisements 412, such as advertisements 414, 416 produced by respective advertisers 418, 420. The advertisements 412 provided in association with the electronic content 404 may be based on a value group associated with a user 422 of the client device 406. The value group of the user 422 may indicate an estimated amount of value that the user 422 may provide to the advertisers 418, 420 as a customer.

The server 402 may communicate with the client device 406 and the advertisers 418, 420 via a network 424. The network 424 may be representative of any one or combination of multiple different types of wired and wireless networks, such as the Internet, cable networks, satellite networks, wide area wireless communication networks, wireless local area networks, and public switched telephone networks (PSTN).

The server 402 includes one or more processors represented by the processor 426. The server 402 also includes memory 428 that is accessible by the processor 426. The memory 428 is an example of computer-readable storage media and may include volatile memory, nonvolatile memory, removable memory, non-removable memory, or a combination thereof. For example, the memory 428 may include, but is not limited to, RAM, ROM, EEPROM, flash memory, one or more hard disks, solid state drives, floppy disks, optical memory (e.g., CD, DVD), or other non-transient memory technologies.

The memory 428 stores a data store 430. The data store 430 stores customer data 432 that includes information about customers of advertisers that produce advertisements that are provided in association with electronic content in response to content requests. In particular, the customer data 432 includes first advertiser customer data 434 that includes information about customers of the first advertiser 418 and second advertiser customer data 436 that includes information about customers of the second advertiser 420. The first advertiser customer data 434 and the second advertiser customer data 436 may indicate purchases by customers from the advertisers 418, 420, dwell time of customers on respective websites of the advertisers 418, 420, number of pages of the respective websites of the advertisers 418, 420 visited by customers, or a combination thereof.

The data store 430 also stores classification data 438 including information about individuals that submit content requests to the server 402. In some cases, the classification data 438 is received from a cookie application executing in conjunction with a browser application of a client device, such as the client device 406. For example, the server 402 may provide a search engine application to the client device 406 and install a cookie application on the client device 406 that collects data related to search queries, browsing history, etc. of the user 422. In particular, the classification data 438 may indicate search queries submitted by individuals, browsing history of individuals, advertisements previously selected by individuals, preferences of individuals, profile information of individuals, or combinations thereof.

The data store 430 also stores advertiser classifiers 440. The advertiser classifiers 440 may be utilized to classify individuals with respect to respective advertisers. In some cases, the individuals may be placed into groups based on an estimated amount of value that each particular individual may provide to the respective advertisers. In particular, the advertiser classifiers 440 include a first advertiser classifier 442 that may classify individuals with respect to the first advertiser 418. The advertiser classifiers 440 may also include a second advertiser classifier 444 that may classify individuals with respect to the second advertiser 420.

The data store 430 also stores advertiser feedback 446. The advertiser feedback 446 may be provided by advertisers and relates to whether certain individuals are correctly classified by the respective advertiser classifiers 440. The advertiser feedback 446 may be based on whether or not an individual purchases products and/or services from a particular advertiser after selecting an advertisement of the particular advertiser, dwell time of an individual on a website of a particular advertiser after selecting an advertisement of the particular advertiser, and so on. In a particular example, the first advertiser 418 may provide feedback indicating that the user 422 purchased a product from the first advertiser 418 after the user 422 selected the advertisement 414, which was provided in association with the electronic content 404 in response to the content request 408.

The memory 428 also stores a content management system 448 that manages content requests and responses to the content requests. The memory 428 also stores an advertising management system 450 that provides advertisements in association with responses to content requests.

In particular, the content management system 448 includes a content request module 452 that is executable by the processor 426 to receive a content request from a client device, where the content request is submitted in response to input from a user of the client device. For example, the content request module 452 may receive the content request 408 from the client device 406 in response to activation of one or more input devices of the client device 406 by the user 422.

The content management system 448 also includes a content response module 454 that is executable by the processor 426 to generate a response to content requests received by the content request module 452. The content response module 452 may identify content that satisfies a particular content request and then send a response including the content to the requesting client device. In a particular example, the content response module 454 determines that the electronic content 404 satisfies the content request 408 and sends the electronic content 404 to the client device 406. In some situations, one or more advertisements may be provided in association with the response to the content request. In these cases, the content response module 454 may invoke the advertising management system 450 to identify advertisements to provide in association with the response to the content request before sending the response to the requesting client device.

The advertising management system 450 includes a classifier module 456 that is executable by the processor 426 to train and maintain classifiers, such as the classifiers 442, 444. In particular, the classifier module 456 may utilize the customer data 432, the classification data 438, and/or other data to train a particular advertiser classifier 440. Additionally, the classifier module 456 may utilize the advertiser feedback 446 to improve the accuracy of the respective advertiser classifiers 440.

In an illustrative example, the classifier module 456 may train the first classifier 442 based on the first advertiser customer data 434 and the classification data 438. In particular, the classifier module 456 may examine the first advertiser customer data 434 in relation to the classification data 438 in order to identify individuals that may provide value to the first advertiser 418 as a customer. To illustrate, the classifier module 456 may determine that individuals with certain web browsing habits and/or individuals submitting search queries including particular keywords have a specified likelihood of becoming customers of the first advertiser 418. In this way, the first classifier 442 may be trained, such that a new user submitting a content request and having certain classification data may be placed into a particular group by the first classifier 442 based on an estimated amount of value that the new user may provide to the first advertiser 418 as a customer.

The classifier module 456 may further train the advertiser classifiers 440 based on the advertiser feedback 446. For example, the classifier module 456 may receive feedback from an advertiser indicating that a particular individual was correctly classified or incorrectly classified. In some cases, the classifier module 456 may receive feedback from an advertiser indicating that an individual placed into a group with individuals that are not likely to purchase products and/or services from the advertiser did in fact make a purchase from the advertiser. In other cases, the classifier module 456 may receive feedback from an advertiser indicating that an individual placed into a group including individuals that are likely to purchase products and/or services from the advertiser spent only a short amount of time on the website of the advertiser without making any purchases.

The advertising management system 450 also includes an advertisement identification module 458 that is executable by the processor 426 to identify advertisements that may be provided in association with responses to content requests. In particular, after receiving a content request, such as the content request 408, and determining content that satisfies the content request, such as the electronic content 404, the advertisement identification module 458 may be invoked to identify advertisers that have indicated interest in particular advertisements being provided in association with the response to the content request. For example, advertisers may submit bids in an auction in order to have their advertisements provided in association with a response to a content request. In some cases, the bids may be directed to particular content, such as particular keywords or particular content related to a webpage or for a particular website. In this way, the advertiser identification module 458 may identify advertisements from a pool of advertisements where the respective advertisers producing the advertisements have indicated an interest in their advertisements being provided in association with responses to content requests.

The advertising management system 450 also includes a user classification module 460 that is executable by the processor 426 to place an individual submitting a content request into a particular group. In particular, once a content request is received by the server 402 and advertisements are identified that are to be provided in association with the response to the content request, the user classification module 460 may classify the individual submitting the request with respect to each advertiser. In an illustrative example, the user 422 may be placed into a first value group or a second value group with respect to the first advertiser 418 and the second advertiser 420 by the first classifier 442 and/or the second classifier 444. In some cases, the first value group may include individuals that are likely to provide a particular amount of value to a respective advertiser as a customer, while the second value group may include individuals that are likely to provide a different amount of value to the respective advertiser as a customer.

In addition, the advertising management system 450 stores an auction module 462 that is executable by the processor 426 to conduct an auction between advertisers based on bids submitted by the advertisers related a value group of a particular individual. The auction may be a Vickrey auction, a generalized second price auction, another type of auction, or combinations thereof. The advertisers participating in the auction may be the advertisers producing the advertisements identified by the advertisement identification module 458 that have indicated an interest in having their advertisements provided in association with a particular content request.

In an illustrative implementation, the auction module 462 may retrieve data from the advertisement identification module 458 indicating that the first advertiser 418 and the second advertiser 420 have indicated an interest in having the first advertisement 414 and the second advertisement 416 provided in association with the electronic content 404 in response to the content request 408. Additionally, the auction module 462 may retrieve data from the user classification module 460 indicating that the user 422 is classified according to a first value group with respect to the first advertiser 418 and according to a second value group with respect to the second advertiser 420. The auction module 462 also determines the bids submitted by the advertisers 418, 420 for the value group of the user 422 associated with each respective advertiser 418, 420. Continuing with the above implementation, the auction module 462 may determine the bid of the first advertiser 418 for the first value group and the bid of the second advertiser 420 for the second value group. Further, the auction module 462 determines the advertiser 418, 420 submitting the highest bid with respect to the user 422.

The advertising management system 450 also includes an advertising module 464 that is executable by the processor 426 to determine one or more particular advertisements to be provided to a client device in association with a response to a content request. In particular, based on the results of an auction conducted by the auction module 462, the advertising module 464 may identify particular advertisements that are produced by the advertisers submitting the highest bids in the auction. In some cases, the advertising module 464 may determine an order of the respective advertisers according to the bids submitted by each advertiser from a highest bid to a lowest bid for a particular content request.

The advertising module 464 may designate that the particular advertisements produced by the highest bidders are to be provided in association with a response to a content request. In some cases, the arrangement of the particular advertisements is based on the bid submitted by the respective advertisers. For example, an advertisement of an advertiser submitting the highest bid may be displayed more prominently than other ads, such as at the top of a webpage or first in a list of advertisements. After identifying the advertisements to be provided in association with a response to a content request, the advertising module 464 may provide the advertisements to the content response module 454 in addition to any data indicating placement of the advertisements with respect to each other and/or specifying placement on a webpage.

In a particular example, the advertising module 464 may determine that the advertisements 414 and 416 are to be provided in association with the electronic content 404 in response to the content request 408 and that the first advertiser 418 submitted a higher bid in an auction than the second advertiser 420. Accordingly, the advertising module 464 may determine that the first advertisement 414 will be displayed in a higher position of a list of advertisements displayed on the webpage 410 than the second advertisement 416. Additionally, the advertising module 464 may provide data to the content response module 454 indicating that the first and second advertisements 414, 416 are to be provided in association with the electronic content 404 and indicating the order of placement in the list of advertisements of the first advertisement 414 and the second advertisement 416.

Although, the content management system 448 and the advertising management system 450 are shown in FIG. 4 as components of the server 402, in other implementations, the content management system 448 and the advertising management system 450 may be components of separate servers and/or may be part of separate entities. For example, the content management system 448 may be a component of a content publisher, while the advertising management system 450 is a component of an advertising management service.

FIGS. 5-8 show methods 500-800, respectively, to provide advertisements based on classifying individuals into one or more value groups with respect to particular advertisers. The methods 500-800 are illustrated as a collection of blocks in a logical flow graph, which represent a sequence of operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process.

FIG. 5 illustrates a process 500 to provide advertisements to a user of a client device in response to a request for content based on an auction between advertisers and a value group of the user. At 502, a server receives a request for particular content from a client device. The request may be for content of a webpage, a request to view an email, a search query including one or more keywords, or a combination thereof.

At 504, the server identifies content satisfying the request, such as a webpage including requested content or search results based on keywords of a search request. At 506, the server identifies particular advertisements that may be provided in association with the content that satisfies the request. For example, the server may identify the particular advertisements because the advertisers producing the respective advertisements have indicated an interest in having the advertisements displayed in association with the content satisfying the request. To illustrate, the advertisers may have indicated interest in having their advertisements displayed in association with the content satisfying the request by submitting bids in an auction.

At 508, the server determines a value group of a client device user submitting the request for content with respect to the advertisers supplying the particular advertisements. The value group of the client device user may include individuals that are predicted to provide a threshold amount of value to the particular advertiser as a customer. The client device user may be associated with different value classes for one or more of the advertisers.

At 510, the server determines one or more of the particular advertisements to be provided in association with the response to the request based on the value group of the user with respect to the respective advertisers supplying the advertisements. In particular, the server may determine the particular advertisements in accordance with results of an auction conducted between the respective advertisers. The results of the auction may be based on bids submitted by the advertisers for the value group of the client device user with respect to each particular advertiser. The one or more particular advertisements to be provided in association with the response to the request for content may be chosen based on the winners of the auction. The server may also determine a placement of the one or more particular advertisements with respect to one another and/or the placement of the advertisements on a webpage based on the results of the auction, such that advertisements associated with advertisers placing higher bids are displayed more prominently than other advertisements.

At 512, the content satisfying the request and the one or more particular advertisements are sent to the client device. In some cases the content and the advertisements may be provided as a webpage and in other cases, the content and advertisements may be provided in another form, such as an electronic message (e.g. email, text message, and the like), a voice mail, or another form of communication.

FIG. 6 illustrates a process 600 for a search engine to provide advertisements to a user of a client device in response to a search request based on a value group of the user. At 602, a search engine receives a search request from a client device. The search request is submitted by a user of the client device and includes one or more keywords.

At 604, the search engine identifies advertisements that may be provided in association with a response to the search request. The search engine may identify the advertisements based on bids submitted by the advertisers producing the advertisements in order to display the advertisements in association with search results related to the one or more keywords. For example, the search request may include the keywords “running” and “shoes” and the advertisements may be identified because the respective advertisers submitted bids for one or both of the keywords or some related keywords, such as “run” or “jogging.”

At 606, the search engine determines a value group of a user of the client device submitting the search request with respect to each of the advertisers producing the advertisements. The value group of the user comprises individuals that are predicted to provide a threshold amount of value to the respective advertisers as a customer. In some cases, the value group of the user may be different for one advertiser than the value group of the user with respect to another advertiser.

At 608, the search engine identifies one or more of the advertisements to be displayed in association with the search results based, at least in part, on the value group of the user and the respective bids submitted by the advertisers producing the advertisements. That is, the search engine compares the bids of each advertiser for the value group of the user with respect to each particular advertiser to determine an order of the bids of the advertisers from highest to lowest. In some situations, the advertisement produced by the advertiser with the highest bid is provided in association with the results from the search request. In other scenarios, advertisements of a number of advertisers are provided in association with the search results and the order of the bids of the advertisers determines placement of the advertisements with respect to each other. For example, when the advertisements are provided in a webpage with the search results, the advertisements may be shown as a list, with the order of the list depending on the results of the auction. To illustrate, the advertisement of the advertiser submitting the highest bid may be placed at the top of the list, while advertisers submitting lower bids occupy lower positions in the list. At 610, the search results are provided to the client device of the user in association with the one or more advertisements.

FIG. 7 illustrates a process 700 to train and modify a classifier of an advertiser based on customer data of the advertiser, classification data of individuals, and feedback provided by the advertiser. At 702, a server receives customer data from an advertiser. The customer data may indicate activity of a plurality of customers with respect to the advertiser. In particular, the customer data of the advertiser may indicate purchases by one or more of a plurality of customers from the advertiser, dwell time of one or more of the plurality of customers on a website of the advertiser, number of pages of the website of the advertiser visited by one or more of the plurality of customers, or a combination thereof.

At 704, the server receives classification data of an individual. The classification data of the individual may indicate search queries submitted by the individual, browsing history of the individual, advertisements previously selected by the individual, preferences of the individual, profile information of the individual, or a combination thereof. The classification data may be collected by an entity, such as a search engine or an advertising management service. In some cases, at least a portion of the classification data is received from a cookie application executing in conjunction with a browser application of a client device of the individual.

At 706, the server determines a value group of the individual with respect to the advertiser based on the customer data and the classification data. The value group may comprise individuals that are predicted to provide a threshold amount of value to the advertiser as a customer. In particular, a classifier associated with the advertiser that has been trained by the customer data of the advertiser and classification data of a number of individuals may be utilized to determine the value group of the individual.

At 708, the server determines whether to provide an advertisement of the advertiser to the client device of the individual based, at least in part, on the value group of the individual with respect to the advertiser. For example, an advertisement of the advertiser may be provided to the client device of the individual when the advertiser has submitted a bid to have an advertisement provided in relation to a content request made by the individual. The bid may have been made in association with the value group of the individual with respect to the advertiser. In addition, the bid may have been a winning bid in an auction conducted between advertisers submitting bids to have their advertisements provided in response to a content request made by the individual.

At 710, the server receives an indication that the advertisement of the advertiser has been selected by the individual. For example, the individual may utilize one or more input devices to select the advertisement when the advertisement is presented in a user interface by the client device of the individual and the server may receive an indication from the client device that the advertisement has been selected. Upon selection of the advertisement, a unique identifier may be assigned by the server to the individual and the client device of the individual may be redirected to a website of the advertiser.

At 712, the server receives feedback from the advertiser related to the value group of the individual (i.e. the classification made by the classifier with respect to the individual). The feedback may include the unique identifier assigned to the individual and indicate activity of the individual with respect to the advertiser. The activity of the individual with respect to the advertiser may include dwell time of the individual on a website of the advertiser, purchase of one or more items of the advertiser by the individual, or a combination thereof.

At 714, the server may modify the classifier of the advertiser based on the feedback. For example, the advertiser may send data to the server indicating that the individual purchased an item from the website of the advertiser. Thus, if the individual was classified as providing little or no value to the advertiser as a customer, the classifier may be modified to indicate that the value provided by the individual to the advertiser is greater (i.e. that the individual should be classified according to a different value group). In another instance, the individual may have been classified as providing a moderate or high amount of value to the advertiser as a customer, and the classifier may not be modified, since the classifier correctly classified the individual.

FIG. 8 illustrates a process 800 for an advertiser to submit bids based on value groups of individuals and to provide advertisements in association with responses to content requests based on the bids. At 802, an advertiser submits a bid for one or more value groups of a plurality of value groups for particular content. For example, the advertiser may submit bids to have its advertisements displayed in association with search results related to certain keywords, in association with a particular website or a particular webpage, in association with particular content of a website or a webpage (e.g. an article on a specified topic), in association with web content provided to individuals in certain locations, and the like.

Each of the value groups may include individuals that are predicted to provide a threshold amount of value to the advertiser as a customer. To illustrate, the value groups may correspond to individuals that are estimated to provide a high amount of value to the advertiser, individuals that are estimated to provide a moderate amount of value to the advertiser, or individuals that are estimated to provide a low amount of value to the advertiser. In some cases, the amounts of value associated with each value group may be determined by the advertiser, while in other cases the amounts of value associated with each value group may be determined by a third party, such as a search engine or an advertising management service.

In some cases, the advertisers may specify that the bids relate to a particular advertisement produced by the advertiser. In other situations, a group of advertisements may be specified by the advertiser and a search engine or advertising management service may select from the group of advertisements when an advertisement of the advertiser is to be provided in association with content satisfying a particular content request. Further, the advertiser may indicate that different advertisements are to be provided to individuals of different value groups.

At 804, the advertiser receives an indication that a user of a client device has selected an advertisement of the advertiser that has been provided in association with a response to a content request. For example, a search engine or advertising management service may provide the advertiser with the indication that the advertisement has been selected. Alternatively, the advertiser may receive the indication directly from the client device as a request to provide content related to the advertisement. In addition, a classifier of the search engine or the advertising management service may have predicted that the user of the client device is included in a particular value group.

At 806, the advertiser provides website content to the client device that is related to the advertisement. The website content may include a detail webpage including information about a particular product or service offered by the advertiser, a home page of the advertiser, or some other landing webpage designated by the advertiser. At 808, the advertiser monitors the behavior of the user of the client device with respect to the website. For example, the advertiser may monitor an amount of time spent by the user viewing one or more pages of the website (i.e. dwell time). The advertiser may also monitor activity of the user with respect to the website. To illustrate, the advertiser may monitor purchases made by the user via the website.

At 810, the advertiser provides feedback to a search engine or other advertising management service related to the predicted value group of the user. The feedback may indicate a level of activity of the user with respect to webpage(s) provided to the user in response to selection of the advertisement. In some scenarios, an amount of money paid by the advertiser to the search engine or the advertising management service for delivering the user to the advertiser may depend on a proper classification of the user by the search engine or the advertising management service.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising:
a processor;
memory accessible by the processor, the memory storing:
a content management system executable by the processor to:
receive a request for content from a client device, the request is associated with a user of the client device;
identify particular content satisfying the request; and
provide the particular content to the client device; and
an advertising management system executable by the processor to:
identify advertisements corresponding to the particular content, each of the advertisements including advertising content of a respective advertiser;
determine a value group of the user with respect to each of the respective advertisers, the value group is one of a plurality of value groups, and each value group including individuals that are predicted to provide a threshold amount of value to the respective advertisers as a customer; and
determine one or more particular advertisements to provide to the client device in association with the particular content based at least in part on the value group of the user.

2. The apparatus of claim 1, further comprising an auction module executable by the processor to conduct an auction between the respective advertisers to determine the one or more particular advertisements to provide to the client device in association with the particular content.

3. The apparatus of claim 2, wherein the auction module is executable by the processor to:
receive bids from each of the respective advertisers with respect to one or more of the plurality of value groups; and
determine an order of the respective advertisers according to the respective bids submitted by each advertiser for the value group of the user with respect to each of the respective advertisers from a highest bid to a lowest bid.

4. The apparatus of claim 3, wherein the one or more particular advertisements to provide in association with the particular content are from the respective advertisers submitting the highest bids.

5. The apparatus of claim 3, wherein the particular content and the one or more particular advertisements are provided to the client device in a webpage or in an electronic message.

6. The apparatus of claim 5, wherein the particular advertisement provided by the respective advertiser submitting the highest bid in the auction is displayed at the top of the webpage.

7. The apparatus of claim 2, wherein the auction is a Vickrey auction, a generalized second price auction, or a combination thereof.

8. One or more computer-readable storage media including instructions that, when executed by a processor, perform operations comprising:
receiving a search request from a client device, the search request submitted by a user of the client device and including one or more keywords;
identifying advertisers submitting bids to display advertisements in association with search results related to the one or more keywords;
determining a value group of the user with respect to each of the advertisers, the value group of the user including individuals that are predicted to provide a threshold amount of value to the advertisers as a customer;
identifying one or more advertisements to be displayed in association with the search results based, at least in part, on the value group of the user with respect to each of the advertisers and the respective bids submitted by the advertisers; and
providing the search results and the one or more advertisements to the client device.

9. The one or more computer-readable storage media of claim 8, wherein a group of individuals included in a particular value group for one advertiser is different from a group of individuals included in the particular value group for an additional advertiser.

10. The one or more computer-readable storage media of claim 8, wherein the search results and the one or more advertisements are provided to the client device in a webpage and the arrangement of the one or more advertisements in the webpage depends on results of an auction based on the bids submitted by the advertisers related to the one or more keywords.

11. The one or more computer-readable media of claim 10, wherein an advertisement provided by a respective advertiser submitting a highest bid for the one or more keywords in the auction is to be displayed first in a list of the one or more advertisements shown on the webpage.

12. A method comprising:
receiving customer data, by a server, from an advertiser, the customer data indicating activity of a plurality of customers with respect to the advertiser, and the server including a processor executing an advertising management system;
receiving, by the server, classification data of an individual, at least a portion of the classification data is received from a cookie application executing in conjunction with a browser application of a client device of the individual;
determining, by the server, a value group of the individual with respect to the advertiser based on the customer data and the classification data, the value group of the individual including individuals that are predicted to provide a threshold amount of value to the advertisers as a customer; and
determining, by the server, whether to provide an advertisement of the advertiser to the client device of the individual based, at least in part, on the value group of the individual with respect to the advertiser.

13. The method of claim 12, wherein the classification data of the individual indicates search queries submitted by the individual, browsing history of the individual, advertisements previously selected by the individual, preferences of the individual, profile information of the individual, or a combination thereof.

14. The method of claim 12, wherein the customer data of the advertiser indicates purchases by one or more of the plurality of customers from the advertiser, dwell time of one or more of the plurality of customers on a website of the advertiser, number of pages of the website of the advertiser visited by one or more of the plurality of customers, or a combination thereof.

15. The method of claim 12, further comprising training, by the server, a classifier of the advertiser based on the customer data and classification data of a plurality of individuals.

16. The method of claim of claim 15, further comprising:
receiving, by the server, an indication that the individual has selected an advertisement of the advertiser;
assigning, by the server, a unique identifier to the individual; and
receiving, by the server, feedback from the advertiser, the feedback including the unique identifier and indicating activity of the individual with respect to the advertiser.

17. The method of claim 16, further comprising modifying, by the server, the classifier of the advertiser based on the feedback.

18. The method of claim 16, wherein the activity of the individual with respect to the advertiser includes dwell time of the individual on a website of the advertiser, purchase of one or more items of the advertiser by the individual, or a combination thereof.

19. The method of claim 16, wherein the feedback indicates that the individual should be classified according to a different value group.

20. The method of claim 15, further comprising training, by the server, an additional classifier of an additional advertiser based on customer data of the additional advertiser and the classification data of the plurality of individuals.
